(19) United States
(12) Patent Application Publication
(10) Pub. No.: US 2025/0375669 A1
(43) Pub. Date: Dec. 11, 2025

(54) STRUCTURALLY ENHANCED PICKLEBALL AND METHOD OF PRODUCING THE SAME

(71) Applicant: Jason D Landry, Keller, TX (US)

(72) Inventor: Jason D Landry, Keller, TX (US)

(21) Appl. No.: 19/212,544

(22) Filed: May 19, 2025

Related U.S. Application Data
(60) Provisional application No. 63/649,403, filed on May 19, 2024.

(51) Int. Cl. A63B 37/00; A63B 102/08; B29C 71/04; B29L 31/54; C08J 3/24; C08J 3/28

(52) U.S. Cl. CPC A63B 37/0098; B29C 71/04; C08J 3/24; C08J 3/28; A63B 2102/08; A63B 2209/00; B29L 2031/54

(57) ABSTRACT

Particular embodiments described herein provide for a pickleball comprising a polymer outer shell, where at least a portion of the polymer outer shell is crosslinked. The pickleball with crosslinked material can be created by receiving manufactured non-crosslinked polymer pickleballs in consumer packaging in a bulk shipping container, removing the manufactured polymer pickleballs from the bulk shipping container, and passing the manufactured polymer pickleballs in the consumer packaging through an electronic beam to crosslink at least a portion of the polymer that comprises the pickleball to create the crosslinked polymer pickleballs.

### CROSS-REFERENCE TO RELATED APPLICATIONS

This disclosure to relates to and claims the benefit of Provisional Application No. 63/649,403, entitled “STRUCTURALLY ENHANCED PICKLEBALL AND METHOD OF PRODUCING SAME” filed in the United States Patent Office on May 19, 2024, which is hereby incorporated by reference in its entirety.

### TECHNICAL FIELD

This disclosure relates in general to the field of sporting goods, and more particularly, to a system, an apparatus, and a method to help enable a structurally enhanced pickleball.

### BACKGROUND

Pickleball was created in 1965 on Bainbridge Island, Washington. The game was created to keep kids entertained during family vacations, using a wiffle ball, badminton net, and improvised paddles. The first pickleball court was built in 1967, and the first tournament took place in 1976. The name “pickleball” is said to have originated from either a reference to the “pickle boat” in crew racing, where oarsmen were chosen from leftovers, or from the creator's dog, Pickles, who would chase the wiffle ball.

Pickleball has quickly become the fastest growing sport in America. Pickleball's sudden surge in popularity is attributed to several factors, including its ease of learning, low-impact nature, affordability, and social aspects. Pickleball has a relatively quick learning curve and an inclusive atmosphere that makes pickleball accessible to a wide range of ages and skill levels, fostering a sense of community and fun. Estimates indicate that 14% of the adult population plays pickleball at least once per year. Despite pickleball's popularity, participants must endure challenges with ball durability and flight consistency. Conventional pickleballs can quickly crack, deform, and lose rigidity, causing inconsistent flight patterns and frequent replacement.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a structurally enhanced pickleball, in accordance with an embodiment of the present disclosure;

FIG. 2A is a simplified cross-sectional block diagram of a structurally enhanced pickleball, in accordance with an embodiment of the present disclosure;

FIG. 2B is a simplified cross-sectional block diagram of a structurally enhanced pickleball, in accordance with an embodiment of the present disclosure;

FIG. 2C is a simplified cross-sectional block diagram of a structurally enhanced pickleball, in accordance with an embodiment of the present disclosure;

FIG. 3A is a simplified block diagram of example details for creating a structurally enhanced pickleball, in accordance with an embodiment of the present disclosure;

FIG. 3B is a simplified block diagram of example details for creating a structurally enhanced pickleball, in accordance with an embodiment of the present disclosure;

FIG. 3C is a simplified block diagram of example details for creating a structurally enhanced pickleball, in accordance with an embodiment of the present disclosure;

FIG. 3D is a simplified block diagram of example details for creating a structurally enhanced pickleball, in accordance with an embodiment of the present disclosure;

FIG. 4A is a simplified block diagram of example details for creating a structurally enhanced pickleball, in accordance with an embodiment of the present disclosure;

FIG. 4B is a simplified block diagram of example details for creating a structurally enhanced pickleball, in accordance with an embodiment of the present disclosure;

FIG. 4C is a simplified block diagram of example details for creating a structurally enhanced pickleball, in accordance with an embodiment of the present disclosure;

FIG. 5A is a simplified block diagram of example details for creating a structurally enhanced pickleball, in accordance with an embodiment of the present disclosure;

FIG. 5B is a simplified block diagram of example details for creating a structurally enhanced pickleball, in accordance with an embodiment of the present disclosure;

FIG. 5C is a simplified block diagram of example details for creating a structurally enhanced pickleball, in accordance with an embodiment of the present disclosure;

FIG. 6A is a simplified block diagram of example details for creating a structurally enhanced pickleball, in accordance with an embodiment of the present disclosure;

FIG. 6B is a simplified block diagram of example details for creating a structurally enhanced pickleball, in accordance with an embodiment of the present disclosure;

FIG. 7 is a simplified block diagram of example details of a structurally enhanced pickleball, in accordance with an embodiment of the present disclosure;

FIG. 8 is a simplified flowchart illustrating potential operations that may be associated with the system, in accordance with an embodiment of the present disclosure;

FIG. 9 is a simplified flowchart illustrating potential operations that may be associated with the system, in accordance with an embodiment of the present disclosure; and

FIG. 10 is a simplified flowchart illustrating potential operations that may be associated with the system, in accordance with an embodiment of the present disclosure.

The FIGURES of the drawings are not necessarily drawn to scale, as their dimensions can be varied considerably without departing from the scope of the present disclosure.

### DETAILED DESCRIPTION

The following detailed description sets forth examples of apparatuses, methods, and systems relating to a process to create a structurally enhanced pickleball in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

The game of pickleball is played using a ball commonly referred to as a pickleball. The pickleball is similar to a wiffle ball and includes a spherical bulb having a plurality of spaced cavities or air holes that promote certain ball flight patterns, trajectory, and spin while reducing weight and altering bounce characteristics. Pickleballs are typically made from hard polymer or plastic such as polypropylene or polyethylene. Pickleballs are manufactured using either rotational molding or injection molding, which influences their durability and flight of the pickle ball. During rotational modeling, polymer or plastic is poured into a mold, gyrated, and then cooled, resulting in a seamless, durable pickleball that tends to perform faster and longer as compared to pickleballs made using injection modeling. During injection modeling, polymer or plastic is poured or injected into two half molds with pre-formed holes and the two halve molds are then glued together to create the pickleball. Pickleballs made using injection molding are relatively cheaper as compared to pickleballs made using rotational modeling however, pickleballs made using injection modeling have a higher tendency to crack along the seams of the pickleball.

Current pickleballs, whether made by rotational molding, injection molding, or some other means, have a relatively short lifespan, often becoming cracked, deformed, or losing stiffness after just fifteen (15) to twenty (20) games. This issue leads to higher costs for players due to frequent replacement of pickleballs and disrupts gameplay with inconsistencies in each pickleball. The variability in ball performance can also impact the overall player experience and fairness in competitive matches. Accordingly, there is currently a need for a pickleball that is more durable than conventional pickleballs.

Disclosed herein is a pickleball that is constructed with non-crosslinked polymers as with conventional pickleballs. The pickleball that is constructed with non-crosslinked polymers is then treated to crosslink the polymer that comprises the pickleball to structurally enhance the durability, stiffness, and shape retention of the crosslinked structurally enhanced pickleball over a much longer duration as compared to a pickleball that is constructed with non-crosslinked polymers. One way to create a crosslinked polymer is by using an electron beam. Exposing a polymer to an electron beam causes the molecular bonds in the polymer to become broken by the electron beam energy and to generate radicals. The radicals react with molecular chains in the polymer to form bonds called crosslinking. A cross-linked polymer is a polymer where individual polymer chains are linked together or crosslinked, forming a three-dimensional network structure. These links can be covalent or ionic bonds, creating a strong, interconnected structure.

In some examples, individual pickleballs are treated with the electron beam to crosslink the polymer used to create the crosslinked structurally enhanced pickleball. In other examples, retail packages that include individual pickleballs are treated with the electron beam to crosslink the polymer used to create the pickleballs. In yet other examples, boxes or containers that include a plurality of retail packages that include individual pickleballs are treated with the electron beam to crosslink the polymer used to create the pickleballs. The absorbed dose, or amount of energy absorbed by the polymer that comprises the pickleball from the electron beam can be between about two (2) kilograys to about four-hundred (400) kilograys and ranges therein (e.g., about twenty (20) kilograys, about eighty (80) kilograys, about one-hundred and forty (140) kilograys, about two hundred (200) kilograys, etc.). In some examples, at the lower end of the amount of energy absorbed by the polymer that comprises the pickleball, the polymer may include additives or the addition of sensitizers or crosslinkers to enhance the crosslinking process. In an example, each pickleball can spend about one (1) second to about six (6) seconds and ranges therein (e.g., about two (2) seconds to about three (3) seconds, about 2.5 seconds to about five (5) seconds, etc.) directly under the electron beam. In some examples, each pickleball is incrementally exposed to the electron beam by exposing the pickleball to the electron beam, allowing the pickleball to cool after being exposed to the electron beam, exposing the pickleball to the electron beam for a second time, allowing the pickleball to cool after being exposed to the electron beam, exposing the pickleball to the electron beam for a third time, etc. until the desired crosslinking of the polymer that comprises the pickleball is achieved.

In a specific illustrative example, each pickleball can be exposed to the electron beam for about one (1) second to about six (6) seconds and ranges therein (e.g., about two (2) seconds to about three (3) seconds, about 2.5 seconds to about five (5) seconds, etc.), allowed to cool between about one (1) minute to about fifteen (15) minutes and ranges therein (e.g., about four (4) minutes to about eight (8) minutes, about six and a half minutes (6 minutes and 30 seconds) to about ten (10) minutes, etc.) exposed to the electron beam again for about one (1) second to about six (6) seconds and ranges therein, etc. In a specific example for an absorbed dose of about two hundred (200) kilograys, the time directly under the electron beam in the range of about two (2) seconds to about four (4) seconds with about four (4) minutes to about ten (10) minutes of cooldown time before being directly under the electron beam again. Note that Kilogray (kGy) measures the absorbed dose or the amount of energy absorbed by the polymer that comprises the pickleball from radiation of the electronic beam. Kilowatt (kW) measures the power of the electron beam, which is the rate at which energy is transferred. Essentially, kilogray is about how much energy is absorbed by the polymer that comprises the pickleball, while kilowatt is about how quickly that energy is being delivered to by the polymer that comprises the pickleball.

It is to be understood that other embodiments may be utilized and structural changes may be made without departing from the scope of the present disclosure. Substantial flexibility is provided by the structurally enhanced pickleball and methods of creating the structurally enhanced pickleball in that any suitable arrangements and configuration may be provided without departing from the teachings of the present disclosure.

### DISCUSSION OF FIGURES

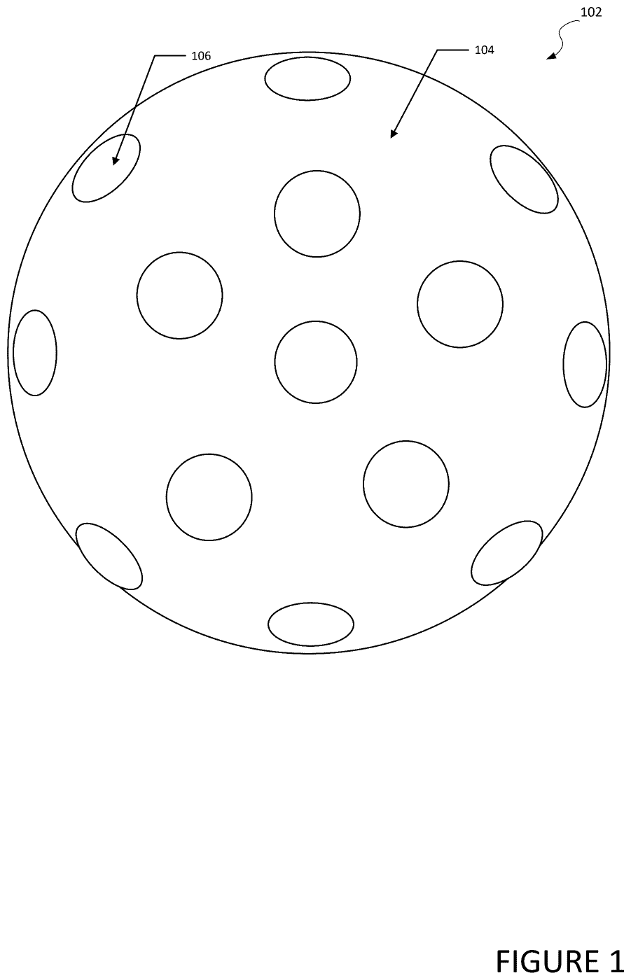

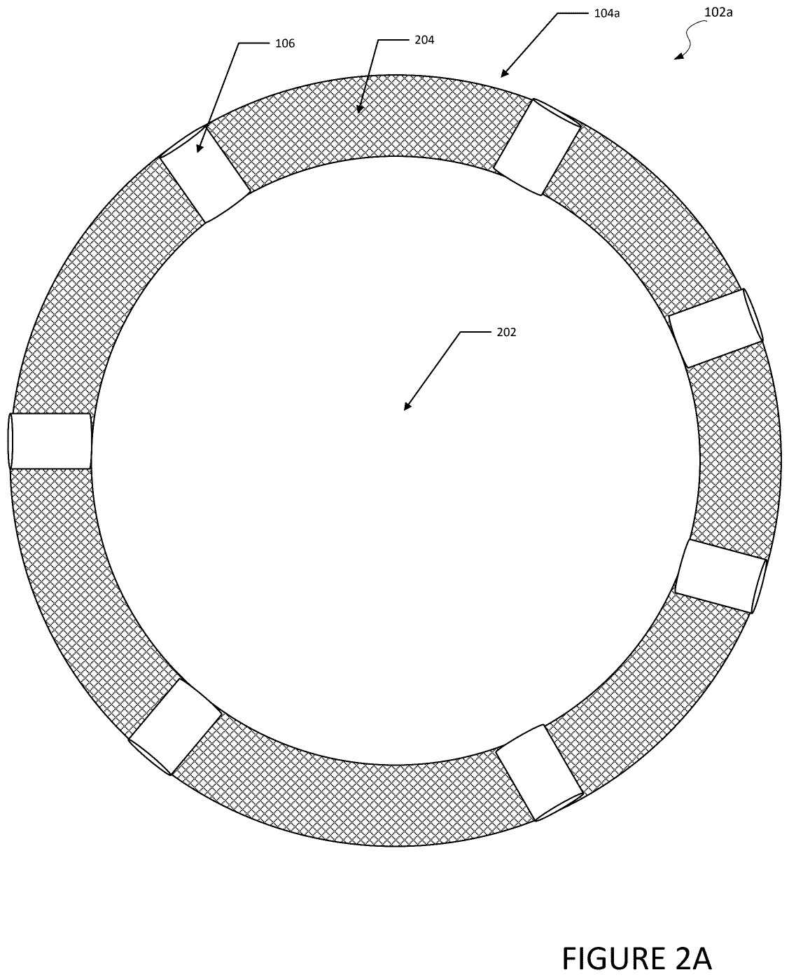

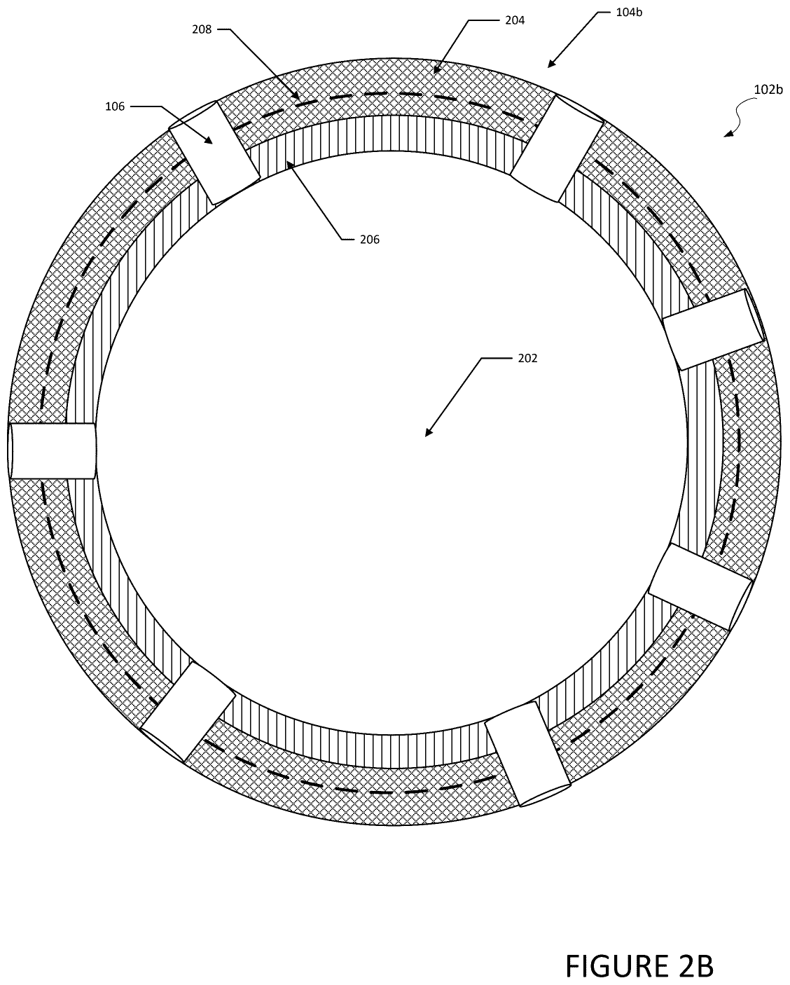

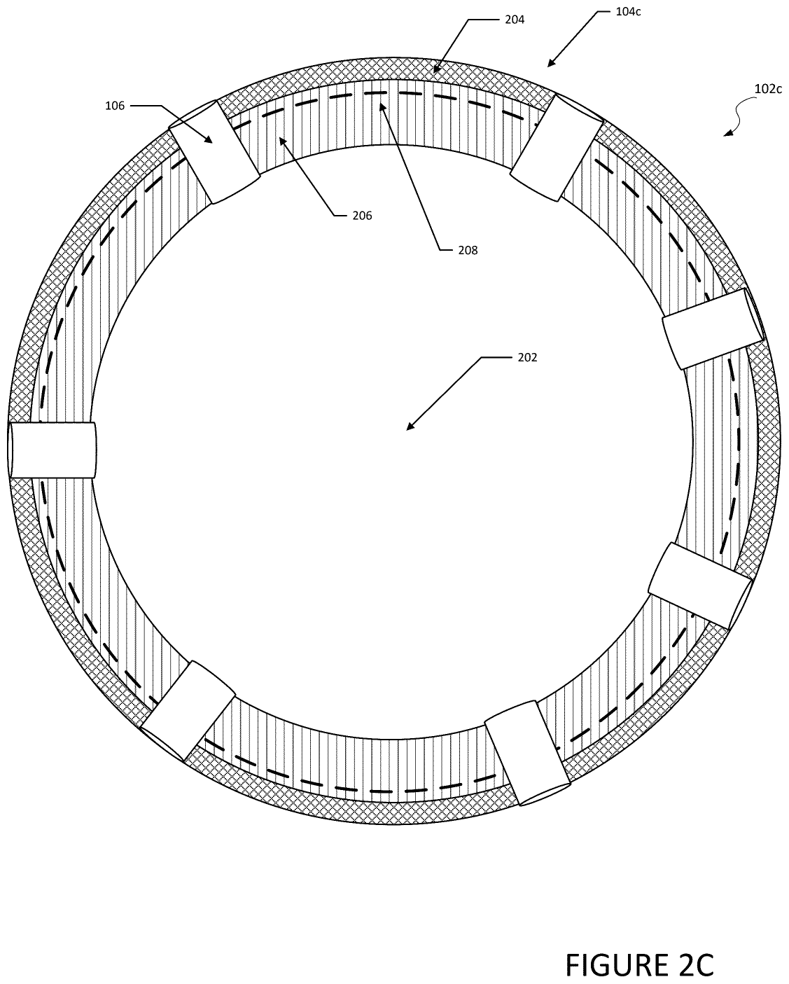

FIG. 1 is simplified block diagram of a particular non-limiting implementation of a structurally enhanced pickleball 102, in accordance with an embodiment of the present disclosure. The structurally enhanced pickleball 102 includes an outer shell 104 and a plurality of cavities 106 (e.g., air holes) that extend through the outer shell 104. The outer shell 104 defines an inner hollow portion (e.g. the inner hollow portion 202 show in FIGS. 2A-2C) and includes crosslinked polymer material (e.g. the crosslinked polymer material 204 show in FIGS. 2A-2C).

The term “pickleball” includes a hollow perforated ball used to play the game of pickleball. In some examples, the pickleball 102 is United States of America Pickleball Association (USAPA) compliant meaning the pickleball 102 possess a diameter that is between 2.874 inches (7.30 cm) to 2.972 inches (7.55 cm), a circumference that is between 9.029 inches (22.93 cm) and 9.337 inches (23.72 cm), and weighs between 0.78 oz (22.11g) and 0.935 oz (26.51g). The term “crosslinked” includes where a polymer chain is connected to another polymer chain and/or parts of the same polymer chain, typically by a covalent or ionic bond that joins two polymer chains. The term “crosslinking” includes the process of creating bonds between separate polymer chains and/or parts of the same polymer chain. The term “polymer” includes a class of natural or synthetic substances composed of very large molecules, called macromolecules, that are multiples of simpler, unspecified number of chemical units called monomers and are not restricted to monomers of the same chemical composition or molecular weight and structure. In a specific example, the term polymer includes polypropylene, polyethylene, and other similar synthetic substances.

Currently, a typical pickleball will typically last for four (4) to five (5) games before it starts to lose its shape and bounce. The current typical pickleball will usually still be fine to practice with but would have to be replaced during a regulated game or tournament. In an example, a current typical pickleball can be treated with an electron beam to change the molecular structure of the pickleball and increase the durability of the pickleball.

More specifically, in a non-limiting illustrative example, an absorbed dose, or amount of energy absorbed by the polymer that comprises the pickleball from the electron beam can be between about two (2) kilograys to about four-hundred (400) kilograys and ranges therein (e.g., about twenty (20) kilograys, about eighty (80) kilograys, about one-hundred and forty (140) kilograys, about two hundred (200) kilograys, etc.) to crosslink the polymer used to create the pickleball without altering the physical dimensions of the pickleball. In a specific non-limiting example, an absorbed dose from the electron beam can be between about one hundred (100) kilograys to about two-hundred and fifty (250) kilograys, and ranges therein, to crosslink the polymer used to create the pickleball without altering the physical dimensions of the pickleball. In yet another specific non-limiting examples, an absorbed dose from the electron beam can be about two hundred (200) kilogray to crosslink the polymer used to create the pickleball without altering the physical dimensions of the pickleball.

In some examples, the structurally enhanced pickleball 102 with the crosslinked polymer can possess improved durability as compared with a current typical pickleball, with the structurally enhanced pickleball 102 lasting 2.4 to 3.1 times longer as compared to a current typical pickleball. Also, the structurally enhanced pickleball 102 can maintain stiffness much longer as compared with a current typical pickleball, losing only three percent (3%) stiffness after ten (10) hours of play as compared to a current typical pickleball. In addition, the structurally enhanced pickleball 102 can maintain shape even after ten (10) hours of play. The structurally enhanced pickleball 102 may see different levels of performance with higher or lower levels of kilogray treatment and/or duration under the electron beam in an electron beam machine, and the intensity of the electron beam and the time exposed to the electron beam can depend on design choice and design limitations. In some examples, at the lower end of the amount of energy absorbed by the polymer that comprises the pickleball, the polymer may include additives or the addition of sensitizers or crosslinkers to enhance the crosslinking process.

Turning to FIG. 2A, FIG. 2A illustrates example details of a particular non-limiting implementation of a structurally enhanced pickleball 102a, in accordance with an embodiment of the present disclosure. As illustrated in FIG. 2A, the structurally enhanced pickleball 102a can include an outer shell 104a and an inner hollow portion 202. The inner hollow portion 202 is surrounded by the outer shell 104a. The outer shell 104a can include the plurality of cavities 106 that extend through the outer shell 104a to the inner hollow portion 202 and crosslinked polymer material 204.

Turning to FIG. 2B, FIG. 2B illustrates example details of a particular non-limiting implementation of a structurally enhanced pickleball 102b, in accordance with an embodiment of the present disclosure. As illustrated in FIG. 2B, the structurally enhanced pickleball 102b can include an outer shell 104b and the inner hollow portion 202. The inner hollow portion 202 is surrounded by the outer shell 104b. The outer shell 104b can include the plurality of cavities 108 that extend through the outer shell 104b to the inner hollow portion 202, the crosslinked polymer material 204, and non-crosslinked polymer material 206. In some examples, the crosslinked polymer material 204 portion is more than half 208 of the outer shell 104b while the non-crosslinked polymer material 206 is less than half 208 of the outer shell 104b such that more than half of the outer shell 204b is crosslinked.

Turning to FIG. 2C, FIG. 2C illustrates example details of a particular non-limiting implementation of a structurally enhanced pickleball 102c, in accordance with an embodiment of the present disclosure. As illustrated in FIG. 2C, the structurally enhanced pickleball 102c can include an outer shell 104c and the inner hollow portion 202. The inner hollow portion 202 is surrounded by the outer shell 104c. The outer shell 104c can include the plurality of cavities 108 that extend through the outer shell 104c to the inner hollow portion 202, the crosslinked polymer material 204, and the non-crosslinked polymer material 206. In some examples, the crosslinked polymer material 204 portion is less than half 208 of the outer shell 104c while the non-crosslinked polymer material 206 is more than half 208 of the outer shell 104c such that less than half of the outer shell 204c is crosslinked.

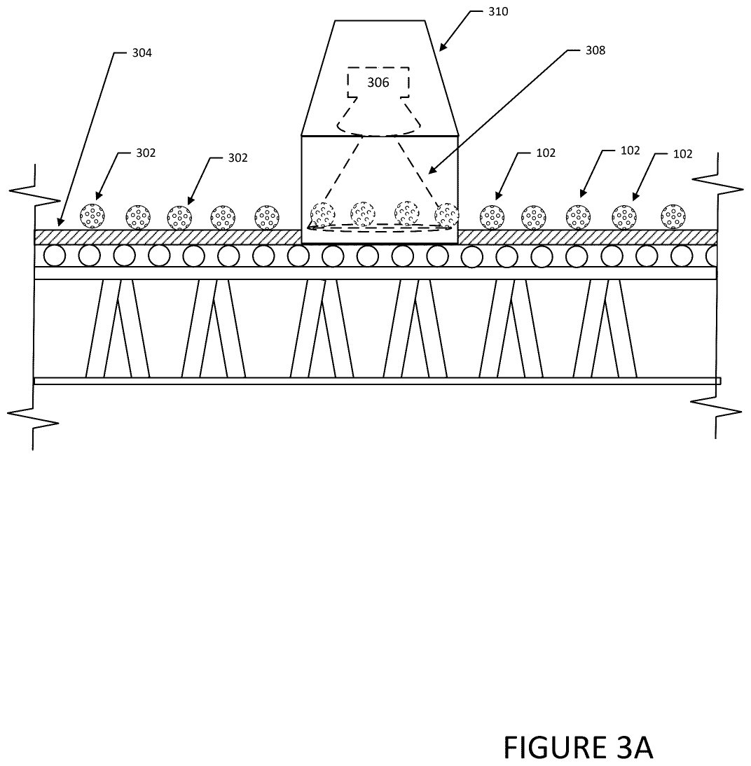

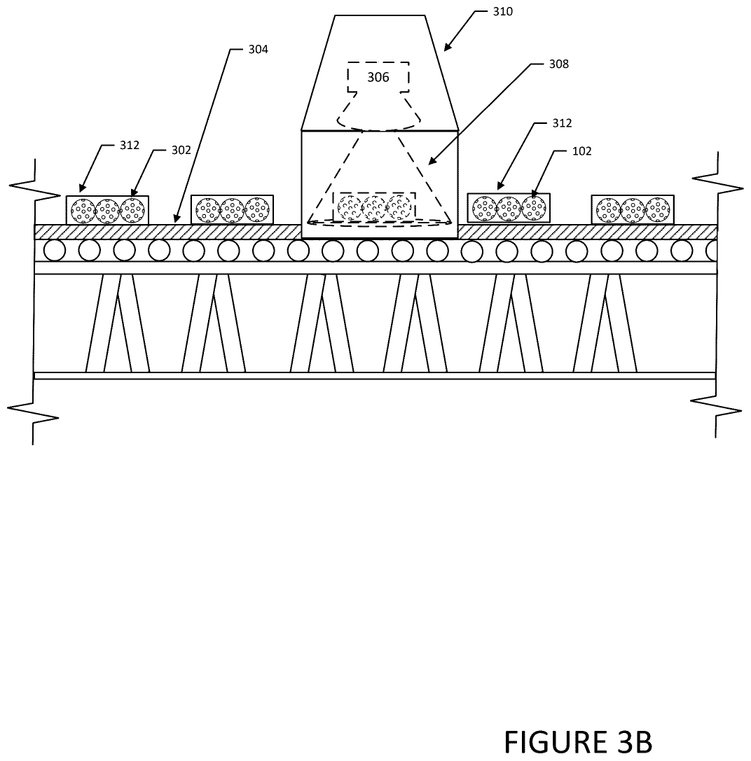

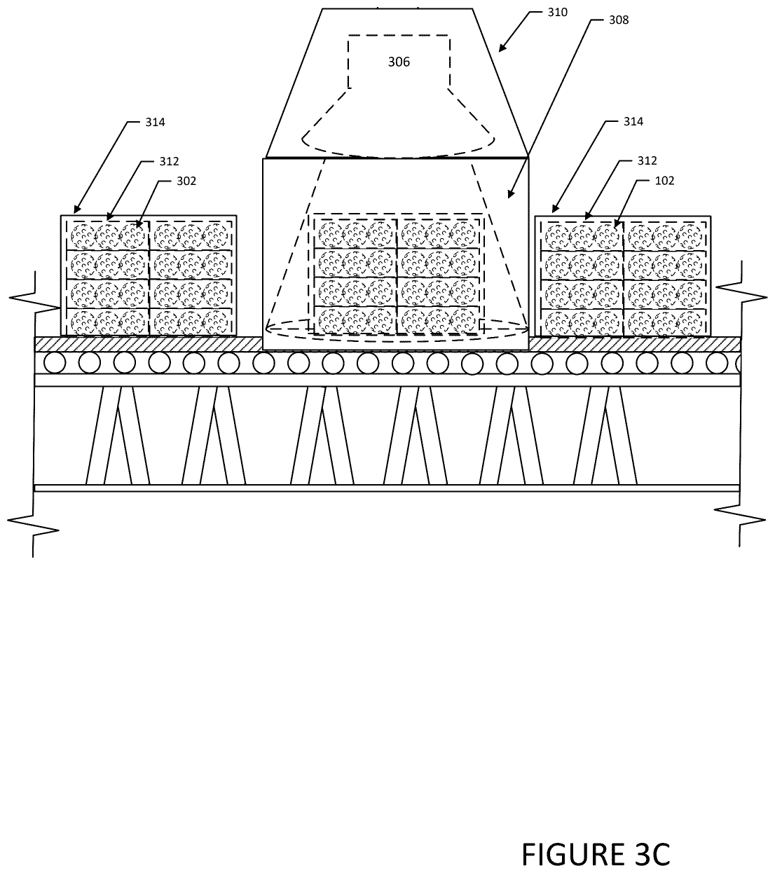

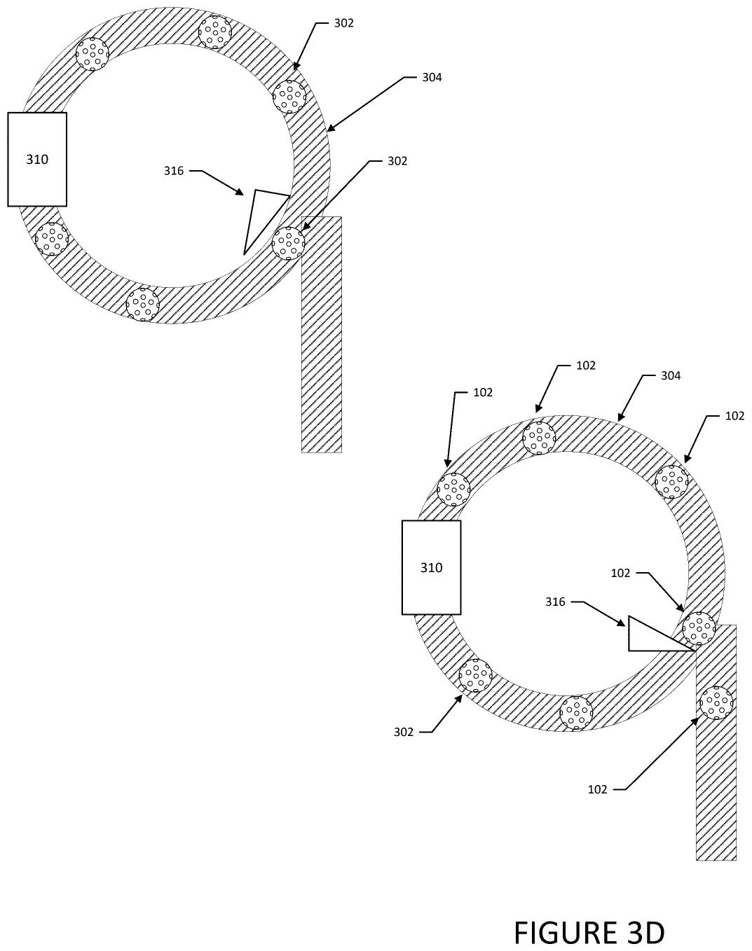

Turning to FIG. 3A, FIG. 3A illustrates example details of a particular non-limiting implementation of a process, method, means, etc. to create the structurally enhanced pickleball 102, in accordance with an embodiment of the present disclosure. As illustrated in FIG. 3A, non-crosslinked manufactured pickleballs 302 are located on a conveyor belt 304. The non-crosslinked manufactured pickleballs 302 can be comprised of one or more polymers that have not been crosslinked.

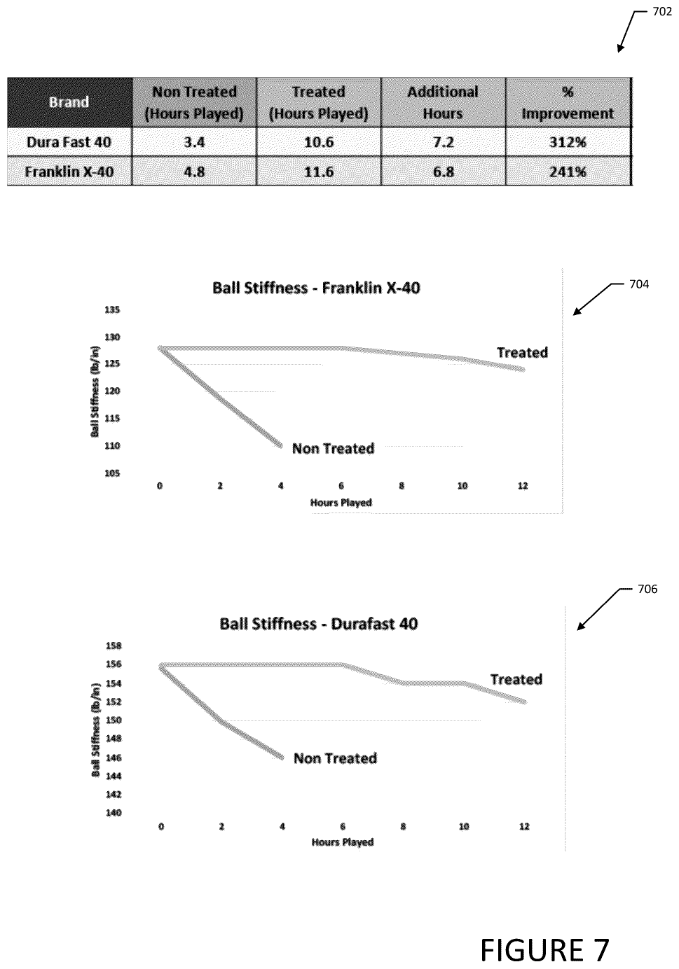

The non-crosslinked manufactured pickleballs 302 can be exposed to an electron beam 308 from an electron beam generation machine 306. For example, the non-crosslinked manufactured pickleballs 302 can be exposed to the electron beam in the range of about one (1) second to about six (6) seconds, depending on the intensity of the electron beam, the desired amount of crosslinked material, design choice, and/or design constraints. In an example, the electron beam 308 from the electron beam generation machine 306 can be housed or contained in a protective housing 310 to help prevent users, other material and/or other equipment from being exposed to the electron beam 308. As the non-crosslinked manufactured pickleballs 302 are conveyed through the electron beam 308 from the electron beam generation machine 306 (e.g., in the range of about one (1) second to about six (6) seconds), a shower of fast moving electrons strike the non-crosslinked manufactured pickleballs 302. The long chain molecules of the polymer that comprise the non-crosslinked manufactured pickleballs 302 are ionized by the fast electrons. The ionized polymer chains connect to each other to form a crosslinked polymer matrix and the structurally enhanced pickleballs 102 are created. The structurally enhanced pickleballs 102 have improved physical properties compared to the non-crosslinked manufactured pickleballs 302 (e.g., as illustrated in FIG. 7).

In an example, each non-crosslinked manufactured pickleball 302 can spend about one (1) second to about six (6) seconds and ranges therein (e.g., about two (2) seconds to about three (3) seconds, about 2.5 seconds to about five (5) seconds, etc.) directly under the electron beam 308. In some examples, each non-crosslinked manufactured pickleball 302 is incrementally exposed to the electron beam 308 by exposing the non-crosslinked manufactured pickleball 302 to the electron beam 308, allowing the non-crosslinked manufactured pickleball 302 to cool after being exposed to the electron beam 308, exposing the non-crosslinked manufactured pickleball 302 to the electron beam 308 for a second time, allowing the non-crosslinked manufactured pickleball 302 to cool after being exposed to the electron beam 308, exposing the non-crosslinked manufactured pickleball 302 to the electron beam 308 for a third time, etc. until the desired crosslinking of the polymer that comprises the pickleball is achieved and the structurally enhanced pickleball 102 is created.

In a specific illustrative example, each of the non-crosslinked manufactured pickleballs 302 can be exposed to the electron beam 308 for about one (1) second to about six (6) seconds and ranges therein (e.g., about two (2) seconds to about three (3) seconds, about 2.5 seconds to about five (5) seconds, etc.), allowed to cool between about one (1) minute to about fifteen (15) minutes and ranges therein (e.g., about four (4) minutes to about eight (8) minutes, about six and a half minutes (6 minutes and 30 seconds) to about ten (10) minutes, etc.) exposed to the electron beam 308 again for about one (1) second to about six (6) seconds and ranges therein, etc. In a specific example for an absorbed dose of about two hundred (200) kilograys, the time directly under the electron beam in the range of about two (2) seconds to about (4) seconds with about four (4) minutes to about ten (10) minutes of cooldown time before being directly under the electron beam 308 again and repeating the process until the structurally enhanced pickleball 102 is created. In some examples, the conveyor belt 304 is a circular conveyor belt to allow the non-crosslinked manufactured pickleball 302 can be exposed to the electron beam 308 several times. The length of the circular conveyor belt can depend on the desired cooling time where a longer conveyor belt allows for a longer cooling time. In some examples, a sensor can detect how many times a specific pickleball has been exposed to the electron beam 308 and after a set number of time, can direct the structurally enhanced pickleball 102 off of the conveyor belt 304.

Turning to FIG. 3B, FIG. 3B illustrates example details of a particular non-limiting implementation of a process, method, means, etc. to create the structurally enhanced pickleball 102, in accordance with an embodiment of the present disclosure. As illustrated in FIG. 3B, the non-crosslinked manufactured pickleballs 302 are located in pickleball packaging 312 on the conveyor belt 304. The pickleball packaging 312 can be the same retail packaging used by retail stores to sell pickleballs. The non-crosslinked manufactured pickleballs 302 can be comprised of one or more polymers that have not been crosslinked.

The non-crosslinked manufactured pickleballs 302 in the pickleball packaging 312 can be exposed to the electron beam 308 from the electron beam generation machine 306. For example, the non-crosslinked manufactured pickleballs 302 in the pickleball packaging 312 can be exposed to the electron beam in the range of about one (1) second to about six (6) seconds, depending on the intensity of the electron beam, the desired amount of crosslinked material, design choice, and/or design constraints. In an example, the electron beam 308 from the electron beam generation machine 306 can be housed or contained in the protective housing 310 to help prevent users, other material and/or other equipment from being exposed to the electron beam 308. As the non-crosslinked manufactured pickleballs 302 in the pickleball packaging 312 are conveyed through the electron beam 308 from the electron beam generation machine 306 (e.g., in the range of about one (1) second to about six (6) seconds), a shower of fast moving electrons strike the non-crosslinked manufactured pickleballs 302. The long chain molecules of the polymer that comprise the non-crosslinked manufactured pickleballs 302 are ionized by the fast electrons. The ionized polymer chains connect to each other to form a crosslinked polymer matrix and the structurally enhanced pickleballs 102 are created. The structurally enhanced pickleballs 102 have improved physical properties compared to the non-crosslinked manufactured pickleballs 302 (e.g., as illustrated in FIG. 7). Note that the non-crosslinked manufactured pickleballs 302 are not removed from the pickleball packaging 312 and remain in the pickleball packaging 312 as the non-crosslinked manufactured pickleballs 302 in the pickleball packaging 312 are conveyed through the electron beam 308.

In an example, each non-crosslinked manufactured pickleball 302 in the pickleball packaging 312 can spend about one (1) second to about six (6) seconds and ranges therein (e.g., about two (2) seconds to about three (3) seconds, about 2.5 seconds to about five (5) seconds, etc.) directly under the electron beam 308. In some examples, each non-crosslinked manufactured pickleball 302 in the pickleball packaging 312 is incrementally exposed to the electron beam 308 by exposing the non-crosslinked manufactured pickleball 302 in the pickleball packaging 312 to the electron beam 308, allowing the non-crosslinked manufactured pickleball 302 in the pickleball packaging 312 to cool after being exposed to the electron beam 308, exposing the non-crosslinked manufactured pickleball 302 in the pickleball packaging 312 to the electron beam 308 for a second time, allowing the non-crosslinked manufactured pickleball 302 in the pickleball packaging 312 to cool after being exposed to the electron beam 308, exposing the non-crosslinked manufactured pickleball 302 in the pickleball packaging 312 to the electron beam 308 for a third time, etc. until the desired crosslinking of the polymer that comprises the pickleball is achieved and the structurally enhanced pickleball 102 is created.

In a specific illustrative example, each of the fast-moving non-crosslinked manufactured pickleball 302 in the pickleball packaging 312 can be exposed to the electron beam 308 for about one (1) second to about six (6) seconds and ranges therein (e.g., about two (2) seconds to about three (3) seconds, about 2.5 seconds to about five (5) seconds, etc.), allowed to cool between about one (1) minute to about fifteen (15) minutes and ranges therein (e.g., about four (4) minutes to about eight (8) minutes, about six and a half minutes (6 minutes and 30 seconds) to about ten (10) minutes, etc.) exposed to the electron beam 308 again for about one (1) second to about six (6) seconds and ranges therein, etc. In a specific example for an absorbed dose of about two hundred (200) kilograys, the time directly under the electron beam in the range of about two (2) seconds to about (4) seconds with about four (4) minutes to about ten (10) minutes of cooldown time before being directly under the electron beam 308 again and repeating the process until the structurally enhanced pickleball 102 is created.

Turning to FIG. 3C, FIG. 3C illustrates example details of a particular non-limiting implementation of a process, method, means, etc. to create the structurally enhanced pickleball 102, in accordance with an embodiment of the present disclosure. As illustrated in FIG. 3C, the non-crosslinked manufactured pickleballs 302 are located in the pickleball packaging 312, in shipping boxes 314, and on the conveyor belt 304 (not referenced). The shipping boxes 314 can be used to ship the pickleballs in the pickleball packaging 312 to storage facilities and/or retail stores. The non-crosslinked manufactured pickleballs 302 can be comprised of one or more polymers that have not been crosslinked.

The non-crosslinked manufactured pickleballs 302 in the pickleball packaging 312 in the shipping boxes 314 can be exposed to an electron beam 308 from the electron beam generation machine 306. For example, the non-crosslinked manufactured pickleballs 302 in the pickleball packaging 312 in the shipping boxes 314 can be exposed to the electron beam in the range of about one (1) second to about six (6) seconds, depending on the intensity of the electron beam, the desired amount of crosslinked material, design choice, and/or design constraints. In an example, the electron beam 308 from the electron beam generation machine 306 can be housed or contained in the protective housing 310 to help prevent users, other material and/or other equipment from being exposed to the electron beam 308. As the non-crosslinked manufactured pickleballs 302 in the pickleball packaging 312 in the shipping boxes 314 are conveyed through the electron beam 308 from the electron beam generation machine 306, a shower of fast moving electrons strike the non-crosslinked manufactured pickleballs 302. The long chain molecules of the polymer that comprise the non-crosslinked manufactured pickleballs 302 are ionized by the fast electrons. The ionized polymer chains connect to each other to form a crosslinked polymer matrix and the structurally enhanced pickleballs 102 are created. The structurally enhanced pickleballs 102 have improved physical properties compared to the non-crosslinked manufactured pickleballs 302 (e.g., as illustrated in FIG. 7). Note that the non-crosslinked manufactured pickleballs 302 are not removed from the pickleball packaging 312 or the shipping boxes 314 and remain in the pickleball packaging 312 and the shipping boxes 314 as the non-crosslinked manufactured pickleballs 302 in the pickleball packaging 312 and the shipping boxes 314 are conveyed through the electron beam 308.

Turning to FIG. 3D, FIG. 3D illustrates example details of a particular non-limiting implementation of a process, method, means, etc. to create the structurally enhanced pickleball 102, in accordance with an embodiment of the present disclosure. As illustrated in FIG. 3D, the conveyor belt 304 can be a circular conveyor belt to allow the non-crosslinked manufactured pickleball 302 to be incrementally exposed to the electron beam 308, allowed to cool after being exposed to the electron beam 308, exposed again to the electron beam 308, allowed to cool, etc. until the desired crosslinking of the polymer that comprises the pickleball is achieved and the structurally enhanced pickleball 102 is created. In some examples, a sensor 316 can help detected when a specific non-crosslinked manufactured pickleball 302 has been converted to the structurally enhanced pickleball 102 and move the structurally enhanced pickleball 102 off of the conveyor belt 304 and onto a loading belt 318 where the structurally enhanced pickleball 102 can be prepared for shipping to a retail destination. In some examples, the sensor 316 is a mechanical arm that is activated by another sensor (not show) that can detect when a specific non-crosslinked manufactured pickleball 302 has been converted to the structurally enhanced pickleball 102. In some examples, the specific non-crosslinked manufactured pickleball 302 has been converted to the structurally enhanced pickleball 102 after the specific non-crosslinked manufactured pickleball 302 has passed through the electron beam 308 a predetermined number of times (e.g., three (3) times, four (4) times, etc.). Note that while FIG. 3D illustrates the non-crosslinked manufactured pickleball 302, the above description and FIG. 3D can also be applied to the non-crosslinked manufactured pickleball 302 in the pickleball packaging 312 and can be applied to the non-crosslinked manufactured pickleball 302 in the pickleball packaging 312 in the shipping box 314.

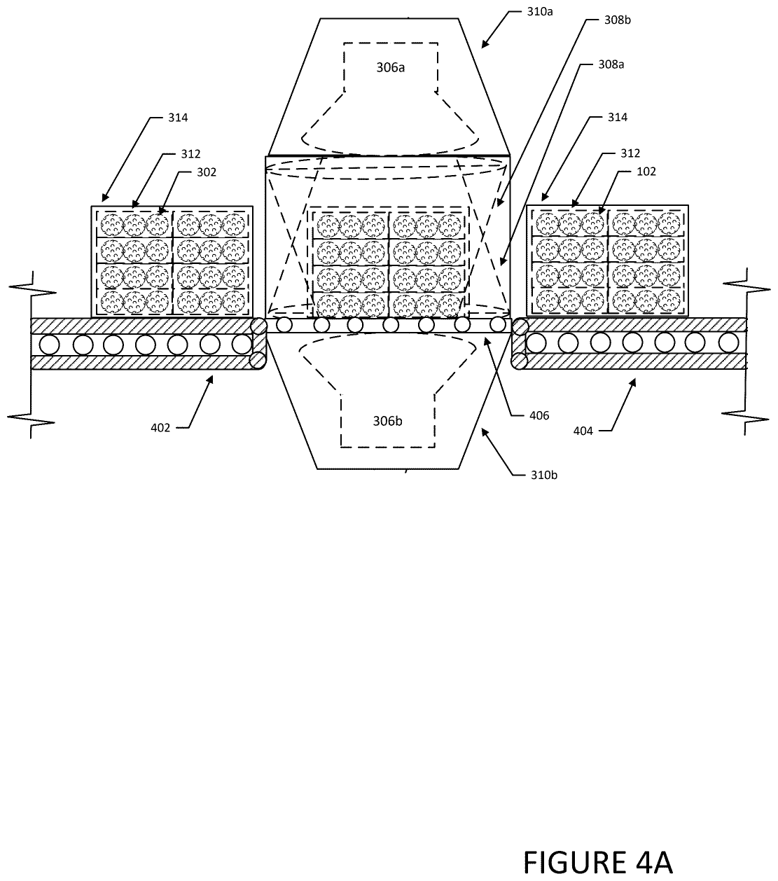

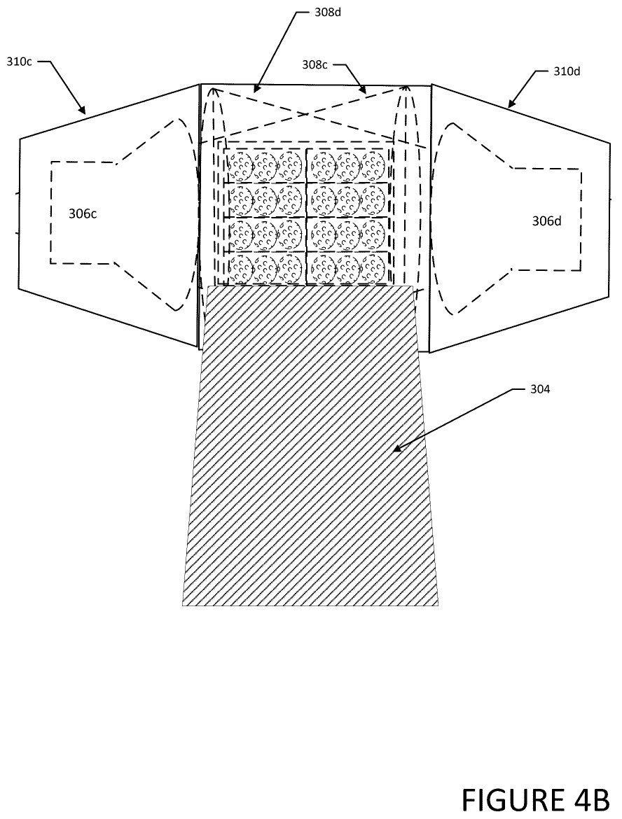

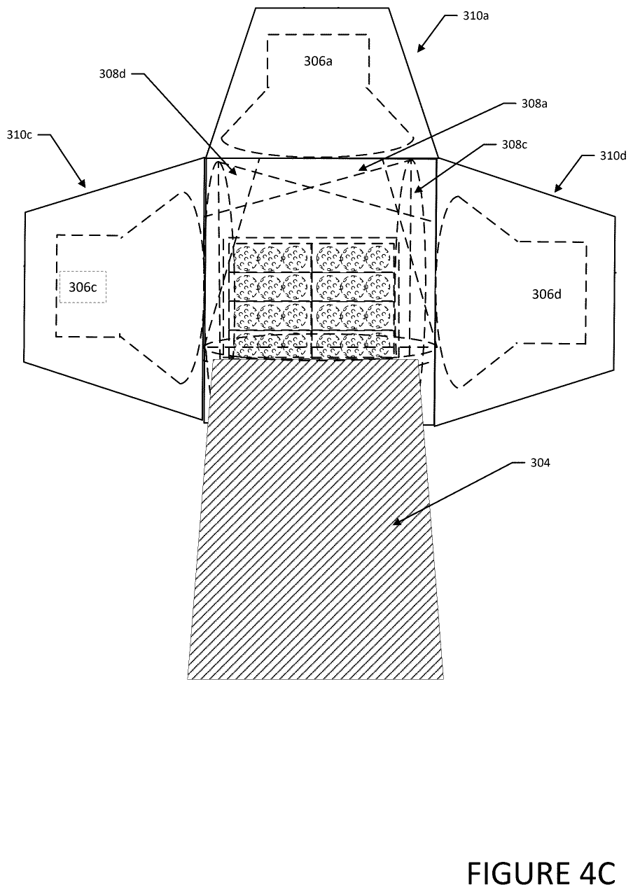

Turning to FIG. 4A, FIG. 4A illustrates example details of a particular non-limiting implementation of a process, method, means, etc. to create the structurally enhanced pickleball 102, in accordance with an embodiment of the present disclosure. As illustrated in FIG. 4A, the non-crosslinked manufactured pickleballs 302 are located in the pickleball packaging 312, in the shipping boxes 314, and on the conveyor belt 402. The shipping boxes 314 can be used to ship the pickleballs in the pickleball packaging 312 to storage facilities and/or retail stores. The non-crosslinked manufactured pickleballs 302 can be comprised of one or more polymers that have not been crosslinked.

The non-crosslinked manufactured pickleballs 302 can be moved by the conveyor belt 402 towards an electron beam 308a from an electron beam generation machine 306a and an electron beam 308b from an electron beam generation machine 306b. In an example, the electron beam 308a from the electron beam generation machine 306a can be housed or contained in a protective housing 310a and the electron beam 308b from the electron beam generation machine 306b can be housed or contained in a protective housing 310b. As illustrated in FIG. 4A, as the non-crosslinked manufactured pickleballs 302 in the pickleball packaging 312 and the shipping boxes 314 are passed through the electron beam 308a from the electron beam generation machine 306a and the electron beam 308b from the electron beam generation machine 306b (e.g., in the range of about one (1) second to about six (6) seconds), a shower of fast moving electrons strike the non-crosslinked manufactured pickleballs 302. The long chain molecules of the polymer that comprise the non-crosslinked manufactured pickleballs 302 are ionized by the fast electrons. The ionized polymer chains connect to each other to form a crosslinked polymer matrix and the structurally enhanced pickleballs 102 are created. The electron beam 308a can originate from a first direction and the electron beam 308b can originate from a second opposite direction.

In some examples, an electron beam permeable surface 406 (e.g., a metal grate with rollers) helps to support the shipping boxes 314 as they are passed through the electron beam 308a from the electron beam generation machine 306a and the electron beam 308b from the electron beam generation machine 306b without affecting the electron beam 308a or the electron beam 308b. In some examples, the shipping boxes 314 are pushed along the electron beam permeable surface 406 towards the conveyor belt 404 by the shipping boxes 314 being moved from the conveyor belt 402 onto the electron beam permeable surface 406. In some examples, the electron beam permeable surface 406 can include powered rollers to help the shipping boxes 314 move across the electron beam permeable surface 406 and onto the conveyor belt 404. The structurally enhanced pickleballs 102 have improved physical properties compared to the non-crosslinked manufactured pickleballs 302 (e.g., as illustrated in FIG. 7). Note that the non-crosslinked manufactured pickleballs 302 are not removed from the pickleball packaging 312 or the shipping boxes 314 and remain in the pickleball packaging 312 and the shipping boxes 314 as the non-crosslinked manufactured pickleballs 302 in the pickleball packaging 312 and the shipping boxes 314 are conveyed through the electron beam 308.

Turning to FIG. 4B, FIG. 4B illustrates example details of a particular non-limiting implementation of a process, method, means, etc. to create the structurally enhanced pickleball 102, in accordance with an embodiment of the present disclosure. As illustrated in FIG. 4B, the non-crosslinked manufactured pickleballs 302 (not referenced) are located in the pickleball packaging 312 (not referenced), in shipping boxes 314 (not referenced), and on the conveyor belt 304.

The non-crosslinked manufactured pickleballs 302 can be exposed to an electron beam 308c from an electron beam generation machine 306c and from an electron beam 308d from an electron beam generation machine 306d. In an example, the electron beam 308c from the electron beam generation machine 306c can be housed or contained in a protective housing 310c and the electron beam 308d from the electron beam generation machine 306d can be housed or contained in a protective housing 310d to help prevent users, other material and/or other equipment from being exposed to the electron beams 308c and 308d. In some examples, the protective housing 310c and the protective housing 210 d may be the same housing or part of a single housing. As the non-crosslinked manufactured pickleballs 302 in the pickleball packaging 312 and the shipping boxes 314 are conveyed through the electron beam 308c from the electron beam generation machine 306c and the electron beam 308d from the electron beam generation machine 306d, a shower of fast moving electrons strike the non-crosslinked manufactured pickleballs 302. The long chain molecules of the polymer that comprise the non-crosslinked manufactured pickleballs 302 are ionized by the fast electrons. The ionized polymer chains connect to each other to form a crosslinked polymer matrix and the structurally enhanced pickleballs 102 are created. The structurally enhanced pickleballs 102 have improved physical properties compared to the non-crosslinked manufactured pickleballs 302. Note that the non-crosslinked manufactured pickleballs 302 are not removed from the pickleball packaging 312 or the shipping boxes 314 and remain in the pickleball packaging 312 and the shipping boxes 314 as the non-crosslinked manufactured pickleballs 302 in the pickleball packaging 312 and the shipping boxes 314 are conveyed through the electron beams 308c and 308d. In some examples, the non-crosslinked manufactured pickleballs 302 are not removed from the pickleball packaging 312 but are removed from the shipping boxes 314 and the non-crosslinked manufactured pickleballs 302 remain in the pickleball packaging 312.

Turning to FIG. 4C, FIG. 4C illustrates example details of a particular non-limiting implementation of a process, method, means, etc. to create the structurally enhanced pickleball 102, in accordance with an embodiment of the present disclosure. As illustrated in FIG. 4C, the non-crosslinked manufactured pickleballs 302 (not referenced) are located in the pickleball packaging 312 (not referenced), in shipping boxes 314 (not referenced), and on the conveyor belt 304.

The non-crosslinked manufactured pickleballs 302 can be exposed to the electron beam 308a from an electron beam generation machine 306a, the electron beam 308c from the electron beam generation machine 306c, and the electron beam 308d from the electron beam generation machine 306d. In an example, the electron beam 308a from the electron beam generation machine 306a can be housed or contained in the protective housing 310a, the electron beam 308c from the electron beam generation machine 306c can be housed or contained in the protective housing 310c, and the electron beam 308d from the electron beam generation machine 306d can be housed or contained in the protective housing 310d to help prevent users, other material and/or other equipment from being exposed to the electron beams 308a, 308c, and 308d. In some examples, the protective housing 310a, the protective housing 310c and the protective housing 310d may be the same housing or part of a single housing. As the non-crosslinked manufactured pickleballs 302 in the pickleball packaging 312 and the shipping boxes 314 are conveyed through the electron beam 308a from the electron beam generation machine 306a, the electron beam 308c from the electron beam generation machine 306c, and the electron beam 308d from the electron beam generation machine 306d, a shower of fast moving electrons strike the non-crosslinked manufactured pickleballs 302. The long chain molecules of the polymer that comprise the non-crosslinked manufactured pickleballs 302 are ionized by the fast electrons. The ionized polymer chains connect to each other to form a crosslinked polymer matrix and the structurally enhanced pickleballs 102 are created. The structurally enhanced pickleballs 102 have improved physical properties compared to the non-crosslinked manufactured pickleballs 302. Note that the non-crosslinked manufactured pickleballs 302 are not removed from the pickleball packaging 312 or the shipping boxes 314 and remain in the pickleball packaging 312 and the shipping boxes 314 as the non-crosslinked manufactured pickleballs 302 in the pickleball packaging 312 and the shipping boxes 314 are conveyed through the electron beams 308a, 308c, and 208d. In some examples, the non-crosslinked manufactured pickleballs 302 are not removed from the pickleball packaging 312 but are removed from the shipping boxes 314 and the non-crosslinked manufactured pickleballs 302 remain in the pickleball packaging 312.

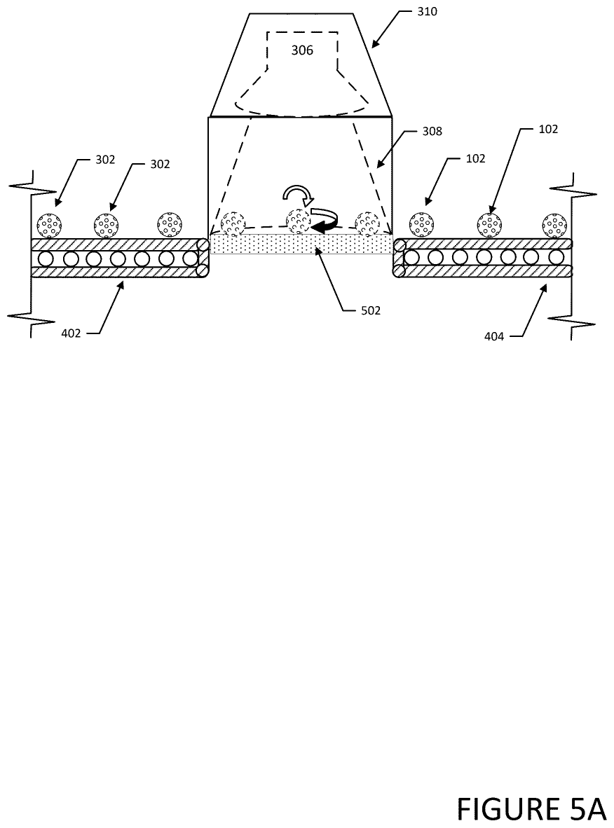

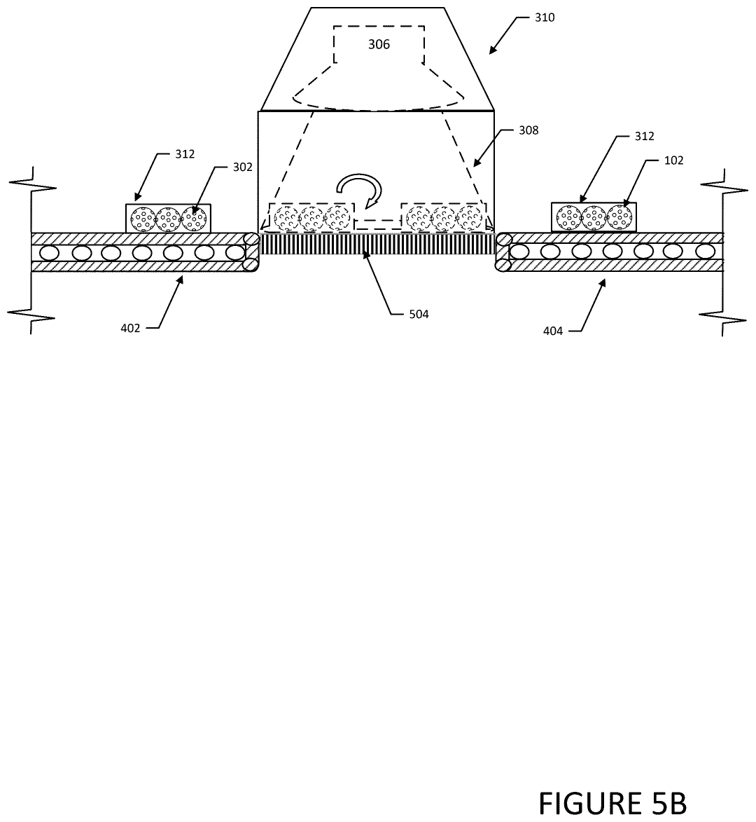

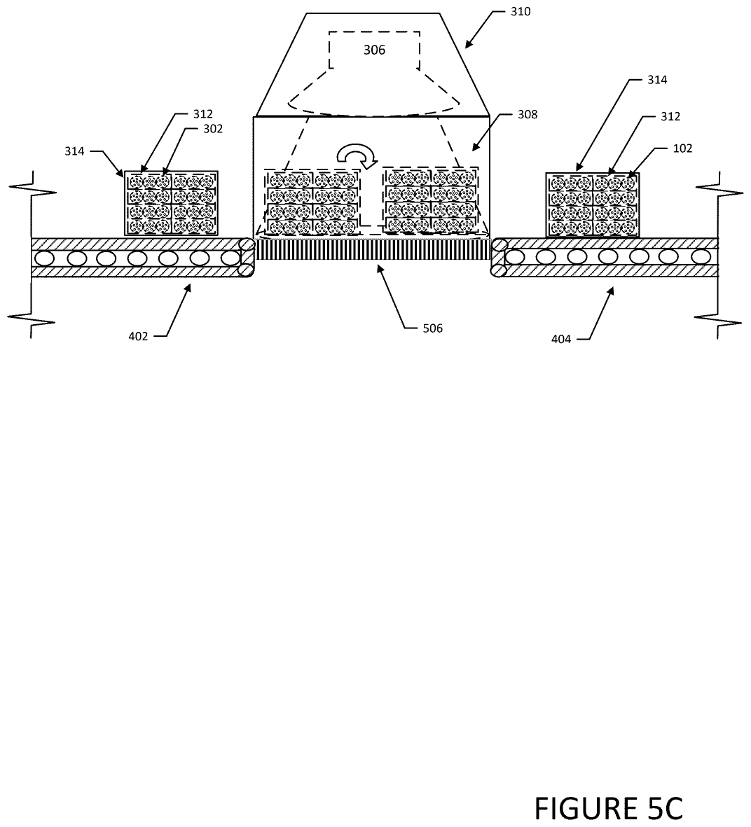

Turning to FIG. 5A, FIG. 5A illustrates example details of a particular non-limiting implementation of a process, method, means, etc. to create the structurally enhanced pickleball 102, in accordance with an embodiment of the present disclosure. As illustrated in FIG. 5A, the non-crosslinked manufactured pickleballs 302 are located on the conveyor belt 402. The non-crosslinked manufactured pickleballs 302 can be moved by the conveyor belt 402 towards and onto a pickleball rotating surface 502 to expose the non-crosslinked manufactured pickleballs 302 to the electron beam 308 from the electron beam generation machine 306. In an example, the electron beam 308 from the electron beam generation machine 306 can be housed or contained in the protective housing 310.

As illustrated in FIG. 5A, as the non-crosslinked manufactured pickleballs 302 are passed through the electron beam 308 from the electron beam generation machine 306, a shower of fast moving electrons strike the non-crosslinked manufactured pickleballs 302. The long chain molecules of the polymer that comprise the non-crosslinked manufactured pickleballs 302 are ionized by the fast electrons. The ionized polymer chains connect to each other to form a crosslinked polymer matrix and the structurally enhanced pickleballs 102 are created. The structurally enhanced pickleballs 102 exit the electron beam 308 onto the conveyor belt 404. In some examples, the pickleball rotating surface 502 can rotate the non-crosslinked manufactured pickleballs 302 as the non-crosslinked manufactured pickleballs 302 are passed through the electron beam 308. More specifically, the pickleball rotating surface 502 can rotate the non-crosslinked manufactured pickleballs 302 ninety degrees (90°) three or more times, one-hundred eight degrees (180°) one or more times, three hundred and sixty degrees (360°) one or more times, or some other type of rotation as the non-crosslinked manufactured pickleballs 302 are passed through the electron beam 308. In some examples, rotating the non-crosslinked manufactured pickleballs 302 as the non-crosslinked manufactured pickleballs 302 are passed through the electron beam 308 can help ensure the polymer in the outer shell (e.g., outer shell 104, illustrated in FIGS. 2A-2C) of the structurally enhanced pickleballs 102 is evenly crosslinked.

Turning to FIG. 5B, FIG. 5B illustrates example details of a particular non-limiting implementation of a process, method, means, etc. to create the structurally enhanced pickleball 102, in accordance with an embodiment of the present disclosure. As illustrated in FIG. 5B, the non-crosslinked manufactured pickleballs 302 are located in the pickleball packaging 312 on the conveyor belt 402. The non-crosslinked manufactured pickleballs 302 can be moved by the conveyor belt 402 towards and onto a pickleball packaging rotating surface 504 to expose the non-crosslinked manufactured pickleballs 302 to the electron beam 308 from the electron beam generation machine 306. In an example, the electron beam 308 from the electron beam generation machine 306 can be housed or contained in a protective housing 310.

As illustrated in FIG. 5B, as the non-crosslinked manufactured pickleballs 302 in the pickleball packaging 312 are passed through the electron beam 308 from the electron beam generation machine 306, a shower of fast moving electrons strike the non-crosslinked manufactured pickleballs 302. The long chain molecules of the polymer that comprise the non-crosslinked manufactured pickleballs 302 are ionized by the fast electrons. The ionized polymer chains connect to each other to form a crosslinked polymer matrix and the structurally enhanced pickleballs 102 are created. The structurally enhanced pickleballs 102 in the pickleball packaging 312 exit the electron beam 308 onto the conveyor belt 404. In some examples, the pickleball packaging rotating surface 504 can rotate the pickleball packaging 312 (and the non-crosslinked manufactured pickleballs 302 in the in the pickleball packaging 312) as the non-crosslinked manufactured pickleballs 302 are passed through the electron beam 308. More specifically, the pickleball packaging rotating surface 504 can rotate the pickleball packaging 312 ninety degrees (90°) three or more times, one-hundred eight degrees (180°) one or more times, three hundred and sixty degrees (360°) one or more times, or some other type of rotation as the non-crosslinked manufactured pickleballs 302 are passed through the electron beam 308. In some examples, rotating the pickleball packaging 312 and the non-crosslinked manufactured pickleballs 302 as the non-crosslinked manufactured pickleballs 302 are passed through the electron beam 308 can help ensure the polymer in the outer shell (e.g., outer shell 104, illustrated in FIGS. 2A-2C) of the structurally enhanced pickleballs 102 is evenly crosslinked.

Turning to FIG. 5C, FIG. 5C illustrates example details of a particular non-limiting implementation of a process, method, means, etc. to create the structurally enhanced pickleball 102, in accordance with an embodiment of the present disclosure. As illustrated in FIG. 5C, the non-crosslinked manufactured pickleballs 302 are located in the pickleball packaging 312 in shipping boxes 314, and on the conveyor belt 402. The non-crosslinked manufactured pickleballs 302 can be moved by the conveyor belt 402 towards and onto a shipping box rotating surface 506 to expose the non-crosslinked manufactured pickleballs 302 to the electron beam 308 from the electron beam generation machine 306. In an example, the electron beam 308 from the electron beam generation machine 306 can be housed or contained in the protective housing 310.

As illustrated in FIG. 5C, as the non-crosslinked manufactured pickleballs 302 in the pickleball packaging 312 and in the shipping boxes 314 are passed through the electron beam 308 from the electron beam generation machine 306, a shower of fast moving electrons strike the non-crosslinked manufactured pickleballs 302. The long chain molecules of the polymer that comprise the non-crosslinked manufactured pickleballs 302 are ionized by the fast electrons. The ionized polymer chains connect to each other to form a crosslinked polymer matrix and the structurally enhanced pickleballs 102 are created. The structurally enhanced pickleballs 102 in the pickleball packaging 312 and the shipping boxes 314 exit the electron beam 308 onto the conveyor belt 404. In some examples, the shipping box rotating surface 506 can rotate the shipping boxes 314 (and the non-crosslinked manufactured pickleballs 302 in the fast-moving pickleball packaging 312 in the shipping boxes 314) as the non-crosslinked manufactured pickleballs 302 are passed through the electron beam 308. More specifically, the shipping box rotating surface 506 can rotate the shipping boxes 314 ninety degrees (90°) three or more times, one-hundred eight degrees (180°) one or more times, three hundred and sixty degrees (360°) one or more times, or some other type of rotation as the non-crosslinked manufactured pickleballs 302 are passed through the electron beam 308. In some examples, rotating the shipping boxes 314 as the non-crosslinked manufactured pickleballs 302 are passed through the electron beam 308 can help ensure the polymer in the outer shell (e.g., outer shell 104, illustrated in FIGS. 2A-2C) of the structurally enhanced pickleballs 102 is evenly crosslinked.

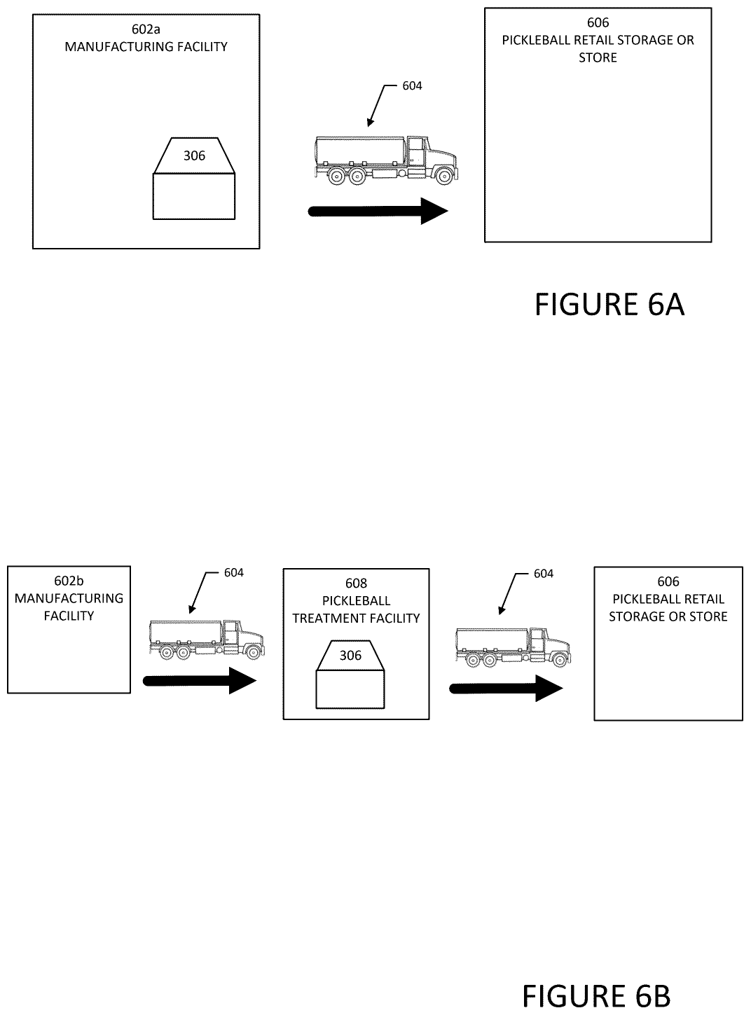

Turning to FIGS. 6A and 6B, FIGS. 6A and 6B illustrate example details of a particular non-limiting implementation of a process, method, means, etc. to create the structurally enhanced pickleball 102, in accordance with an embodiment of the present disclosure. In an illustrative example, the non-crosslinked manufactured pickleballs 302 can be manufactured in a manufacturing facility 602. More specifically, as illustrated by FIG. 6A, the non-crosslinked manufactured pickleballs 302 can be manufactured in manufacturing facility 602a. The manufacturing facility 602a can include the electron beam generation machine 306 that can generate the electron beam 308 (not shown) to crosslink at least a portion of the polymer that was used to create the non-crosslinked manufactured pickleballs 302 and create the structurally enhanced pickleballs 102. The structurally enhanced pickleballs 102 can be shipped or transported to one or more pickle ball storage and/or retail stores 606 using goods transport 604 or some other means. The goods transport 604 may be a delivery truck, train, ship, drone, or some other mobile transport.

In an illustrative example, the non-crosslinked manufactured pickleballs 302 can be manufactured in manufacturing facility 602a and then transported (e.g., using a conveyor belt, fork lift, etc.) to the electron beam generation machine 306 individually, packaged in pickleball packaging (e.g., the pickleball packaging 312), in shipping boxes (e.g., the shipping boxes 314) or some other means. In some examples, the non-crosslinked manufactured pickleballs 302 are converted to the structurally enhanced pickleballs 102 without taking the non-crosslinked manufactured pickleballs 302 out of the shipping boxes, as illustrate in FIG. 3C. In other examples, the non-crosslinked manufactured pickleballs 302 are in the pickleball packaging and the non-crosslinked manufactured pickleballs 302 are converted to the structurally enhanced pickleballs 102 without taking the non-crosslinked manufactured pickleballs 302 out of the pickleball packaging, as illustrate in FIG. 3B. In yet other examples, the non-crosslinked manufactured pickleballs 302 are converted to the structurally enhanced pickleballs 102 on an individual basis, as illustrate in FIG. 3A.

As illustrated by FIG. 6B, the non-crosslinked manufactured pickleballs 302 can be manufactured in manufacturing facility 602b. The manufacturing facility 602b does not include the electron beam generation machine 306. Instead, using the goods transport 604, the non-crosslinked manufactured pickleballs 302 can be delivered to a pickleball treatment facility 608 that does have the electron beam generation machine 306 and can generate the electron beam 308 (not shown) to crosslink at least a portion of the polymer that was used to create the non-crosslinked manufactured pickleballs 302 and create the structurally enhanced pickleballs 102. The structurally enhanced pickleballs 102 can be shipped or transported from the pickleball treatment facility 608 to one or more pickle ball storage and/or retail stores 606 using the goods transport 604 or some other means.

The non-crosslinked manufactured pickleballs 302 can be shipped or transported to the pickleball treatment facility 608 individually, packaged in pickleball packaging (e.g., the pickleball packaging 312), in shipping boxes (e.g., the shipping boxes 314) or some other means. In some examples, the non-crosslinked manufactured pickleballs 302 are converted to the structurally enhanced pickleballs 102 without taking the non-crosslinked manufactured pickleballs 302 out of the shipping boxes, as illustrate in FIG. 3C. In other examples, the non-crosslinked manufactured pickleballs 302 are removed from the shipping boxes but not from the pickleball packaging and the non-crosslinked manufactured pickleballs 302 are converted to the structurally enhanced pickleballs 102 without taking the non-crosslinked manufactured pickleballs 302 out of the pickleball packaging, as illustrate in FIG. 3B. In yet other examples, the non-crosslinked manufactured pickleballs 302 are removed from the shipping boxes and the pickleball packaging and the non-crosslinked manufactured pickleballs 302 are converted to the structurally enhanced pickleballs 102 on an individual basis, as illustrate in FIG. 3A. The structurally enhanced pickleballs 102 can be shipped or transported from the pickleball treatment facility 608 to one or more pickle ball storage and/or retail stores 606 using the goods transport 604 or some other means.

Turning to FIG. 7, FIG. 7 illustrates example non-limiting details of the structurally enhanced pickleball 102, in accordance with an embodiment of the present disclosure. In an illustrative non-limiting example, table 702 illustrates the difference between the number of hours played with a non-crosslinked manufactured pickleball (e.g., the non-crosslinked manufactured pickleballs 302) as compared to the hours played with a structurally enhanced pickleball (e.g., the structurally enhanced pickleball 102). Graph 704 illustrates the difference between ball stiffness of a specific non-crosslinked manufactured pickleball, the Franklin® X-40@ pickleball, and the ball stiffness when the Franklin® X-40® pickleball is exposed to the electron beam to cross link at least a portion of the polymer that comprises the Franklin® X-40® pickleball to create the structurally enhanced pickleball 102. Graph 706 illustrates the difference between ball stiffness of a specific non-crosslinked manufactured pickleball, the Durafast 40@ pickleball, and the ball stiffness when the Durafast 40@ pickleball is exposed to the electron beam to cross link at least a portion of the polymer that comprises the Durafast 40® pickleball to create the structurally enhanced pickleball 102.

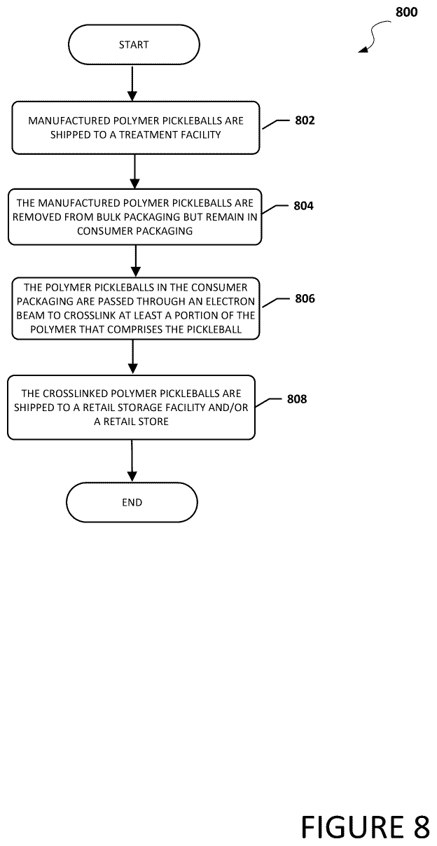

Turning to FIG. 8, FIG. 8 is an example flowchart illustrating possible operations of a flow 800 that may be associated with enabling the creation of the structurally enhanced pickleball 102, in accordance with an embodiment. At 802, manufactured polymer pickleballs are shipped to a treatment facility. For example, the non-crosslinked manufactured pickleballs 302 can be shipped from the manufacturing facility 602b to the pickleball treatment facility 608 in the pickleball packaging 312 in shipping boxes 314. At 804, the manufactured polymer pickleballs are removed from bulk packaging but remain in consumer packaging. For example, the pickleball packaging 312 that includes the non-crosslinked manufactured pickleballs 302 can be removed from the shipping boxes 314. At 806, the polymer pickleballs in the consumer packaging are passed through an electron beam to cross link at least a portion of the polymer that comprises the pickleball. For example, the non-crosslinked manufactured pickleballs 302 in the pickleball packaging 312 can be exposed to the electron beam 308 to crosslink the polymer that comprises the pickleball and to create the structurally enhanced pickleball 102. At 808, the crosslinked polymer pickleballs are shipped to a retail storage facility and/or a retail store. For example, the structurally enhanced pickleball 102 in the pickleball packaging 312 can be shipped to the pickleball retail storage or retail store 606.

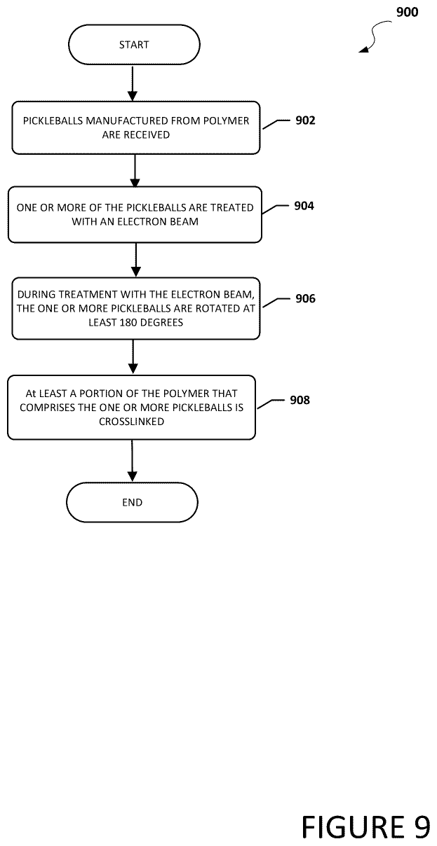

Turning to FIG. 9, FIG. 9 is an example flowchart illustrating possible operations of a flow 900 that may be associated with enabling the creation of the structurally enhanced pickleball 102, in accordance with an embodiment. At 902, pickleballs manufactured from polymer are received. For example, the electron beam generation machine 306 located in the manufacturing facility 602a or the pickleball treatment facility 608 can receive the non-crosslinked manufactured pickleballs 302. At 904, one or more of the pickleballs are treated with an electron beam. For example, the non-crosslinked manufactured pickleballs 302 can be exposed to the electron beam 308. In an example, the non-crosslinked manufactured pickleballs 302 are in the pickleball packaging 312. In other example, the non-crosslinked manufactured pickleballs 302 are in the pickleball packaging 312 and in the shipping boxes 314. At 906, during treatment with the electron beam, the one or more pickleballs are rotated. For example, using the pickleball rotating surface 502, the non-crosslinked manufactured pickleballs 302 are rotated as the non-crosslinked manufactured pickleballs 302 are passed through the electron beam 308. More specifically, the pickleball rotating surface 502 can rotate the non-crosslinked manufactured pickleballs 302 ninety degrees (90°) three or more times, one-hundred eight degrees (180°) one or more times, three hundred and sixty degrees (360°) one or more times, or some other type of rotation as the non-crosslinked manufactured pickleballs 302 are passed through the electron beam 308. In another example, the pickleball packaging rotating surface 504 can rotate the pickleball packaging 312 (and the non-crosslinked manufactured pickleballs 302 in the in the pickleball packaging 312) as the non-crosslinked manufactured pickleballs 302 are passed through the electron beam 308. More specifically, the pickleball packaging rotating surface 504 can rotate the pickleball packaging 312 ninety degrees (90°) three or more times, one-hundred eight degrees (180°) one or more times, three hundred and sixty degrees (360°) one or more times, or some other type of rotation as the non-crosslinked manufactured pickleballs 302 are passed through the electron beam 308. In yet another example, the shipping box rotating surface 506 can rotate the shipping boxes 314 (and the non-crosslinked manufactured pickleballs 302 in the fast-moving pickleball packaging 312 in the shipping boxes 314) as the non-crosslinked manufactured pickleballs 302 are passed through the electron beam 308. More specifically, the shipping box rotating surface 506 can rotate the shipping boxes 314 ninety degrees (90°) three or more times, one-hundred eight degrees (180°) one or more times, three hundred and sixty degrees (360°) one or more times, or some other type of rotation as the non-crosslinked manufactured pickleballs 302 are passed through the electron beam 308. At 908, at least a portion of the polymer that comprises the one or more pickleballs is crosslinked. For example, at least a portion of the polymer that comprises the non-crosslinked manufactured pickleballs 302 can be exposed to the electron beam 308 to crosslink the polymer that comprises the pickleball to create the structurally enhanced pickleball 102.

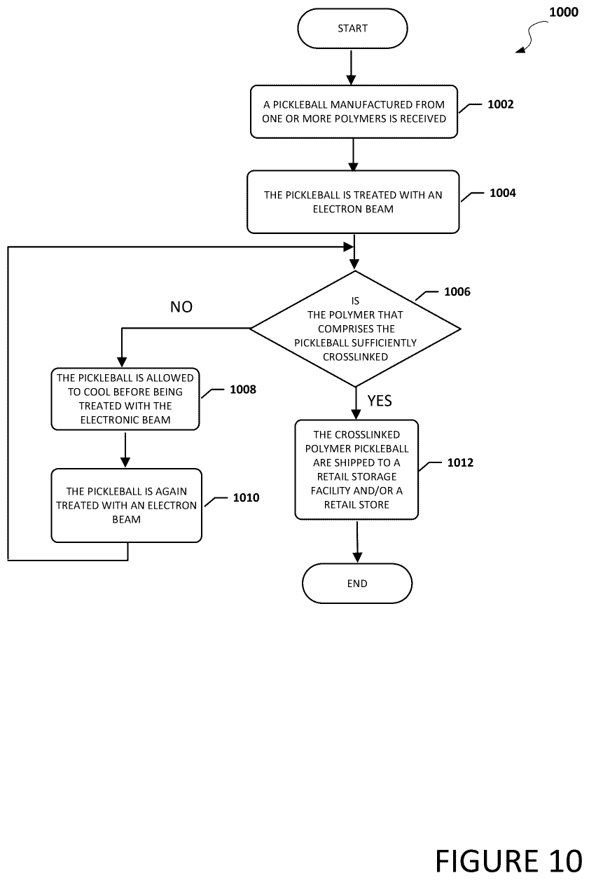

Turning to FIG. 10, FIG. 10 is an example flowchart illustrating possible operations of a flow 1000 that may be associated with enabling the creation of the structurally enhanced pickleball 102, in accordance with an embodiment. At 1002, a pickleball manufactured from one or more polymers is received. At 1004, the pickleball is treated or exposed to an electron beam. For example, the non-crosslinked manufactured pickleball 302 can spend about one (1) second to about six (6) seconds and ranges therein (e.g., about two (2) seconds to about three (3) seconds, about 2.5 seconds to about five (5) seconds, etc.) directly under the electron beam 308. At 1006, the system determines if the polymer that comprises the pickleball is sufficiently crosslinked. If the system determines that the polymer that comprises the pickleball is not sufficiently crosslinked, the pickleball is allowed to cool before being treated again with the electron beam, as in 1008. For example, the non-crosslinked manufactured pickle ball 302 can be allowed to cool between about one (1) minute to about fifteen (15) minutes and ranges therein (e.g., about four (4) minutes to about eight (8) minutes, about six and a half minutes (6 minutes and 30 seconds) to about ten (10) minutes, etc.) before being exposed to the electron beam again. At 1010, the pickleball is again treated with the electron beam. At 1006, the system determines if the polymer that comprises the pickleball is sufficiently crosslinked. If the system determines that the polymer that comprises the pickleball is sufficiently crosslinked, the crosslinked polymer pickleballs are shipped to a retail storage facility and/or a retail store, as in 1012.

In the description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example. The term “about” includes a plus or minus twenty percent (±20%) variation. For example, about one (1) millimeter (mm) would include one (1) mm and ±0.2 mm from one (1) mm. Similarly, terms indicating orientation of various elements, for example, “coplanar,” “perpendicular,” “orthogonal,” “parallel,” or any other angle between the elements generally refer to being within plus or minus five to twenty percent (+/−5-20%) of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the structurally enhanced pickleball 102, especially the creation of the structurally enhanced pickleball 102, and related teachings are readily scalable and can accommodate a large number of components, as well as more complicated/sophisticated arrangements and configurations. Accordingly, the examples provided should not limit the scope or inhibit the broad teachings of the structurally enhanced pickleball 102.

It is also important to note that the operations in the preceding flow diagrams (i.e., FIGS. 8-10) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the structurally enhanced pickleball 102 and the creation of the structurally enhanced pickleball 102 has been illustrated with reference to particular elements and operations, these elements and operations may be replaced by any suitable architecture, protocols, and/or processes that achieve the intended functionality of the structurally enhanced pickleball 102.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
receiving manufactured polymer pickleballs in consumer packaging in a bulk shipping container;
removing the manufactured polymer pickleballs from the bulk shipping container; and
passing the manufactured polymer pickleballs in the consumer packaging through an electronic beam to crosslink at least a portion of a polymer that comprises the manufactured polymer pickleballs to create crosslinked polymer pickleballs.

2. The method of claim 1, wherein the manufactured polymer pickleballs are received from a pickleball manufacturing facility.

3. The method of claim 1, further comprising:
shipping the crosslinked polymer pickleballs to one or more retail stores.

4. The method of claim 1, wherein more than half of the polymer that comprises the manufactured polymer pickleballs is crosslinked.

5. The method of claim 1, wherein less than half of the polymer that comprises the manufactured polymer pickleballs is crosslinked.

6. The method of claim 1, further comprising:
rotating the consumer packaging that includes the manufactured polymer pickleballs at least once as the consumer packaging that includes the manufactured polymer pickleballs passes through the electronic beam.

7. The method of claim 1, further comprising:
rotating the consumer packaging that includes the manufactured polymer pickleballs at least one-hundred and eight degrees (180°) as the consumer packaging that includes the manufactured polymer pickleballs passes through the electronic beam.

8. The method of claim 1, wherein the crosslinked polymer pickleballs are United States of America Pickleball Association (USAPA) compliant.

9. A method comprising:
receiving manufactured polymer pickleballs, wherein the manufactured polymer pickleballs are United States of America Pickleball Association (USAPA) compliant; and
passing the manufactured polymer pickleballs through an electronic beam to crosslink at least a portion of a polymer in each of the manufactured polymer pickleballs to create crosslinked polymer pickleballs, wherein the crosslinked polymer pickleballs are USAPA compliant.

10. The method of claim 9, wherein the manufactured polymer pickleballs are received from a pickleball manufacturing facility.

11. The method of claim 9, wherein more than half of the polymer that comprises the manufactured polymer pickleballs is crosslinked.

12. The method of claim 9, wherein less than half of the polymer that comprises the manufactured polymer pickleballs is crosslinked.

13. The method of claim 9, further comprising:
rotating each of the manufactured polymer pickleballs at least once as each manufactured polymer pickleball passes through the electronic beam.

14. The method of claim 9, wherein an amount of energy absorbed by a specific polymer pickleball as the specific polymer pickleball is passed through the electronic beam is between about two (2) kilograys to about four-hundred (400) kilograys and ranges therein.

15. The method of claim 9, wherein an amount of energy absorbed by a specific polymer pickleball as the specific polymer pickleball is passed through the electronic beam is between about one hundred (100) kilograys to about two-hundred and fifty (250) kilograys.

16. The method of claim 9, wherein each of the manufactured polymer pickleballs are directly under the electron beam in a range of about two (2) seconds to about (4) seconds and an amount of energy absorbed by each of the manufactured polymer pickleballs is about twenty (20) kilograys.

17. The method of claim 9, wherein the manufactured polymer pickleballs are received in consumer packaging.

18. A pickleball comprising:
a polymer outer shell, wherein at least a portion of the polymer outer shell is crosslinked;
a hollow interior that is defined by the polymer outer shell; and
a plurality of cavities that extend through the polymer outer shell to the hollow interior, wherein the pickleball is United States of America Pickleball Association (USAPA) compliant.

19. The pickleball of claim 18, wherein more than half of the polymer outer shell is crosslinked.

20. The pickleball of claim 18, wherein less than half of the polymer outer shell is crosslinked.
